(19) United States
(12) Patent Application Publication
(10) Pub. No.: US 2026/0052201 A1
(43) Pub. Date: Feb. 19, 2026

(54) OPTIMIZING LOAD BALANCING AND FAILOVER ROUTING ACROSS DATA CENTERS LOCATED GLOBALLY

(71) Applicant: International Business Machines Corporation, Armonk, NY (US)

(72) Inventors: Shawn Patrick Mullen, Buda, TX (US); Amir Simon, Round Rock, TX (US); Keith A. Rafferty, Wake Forest, NC (US); Colin Taylor, Markham (CA)

(73) Assignee: International Business Machines Corporation, Armonk, NY (US)

(21) Appl. No.: 18/808,479

(22) Filed: Aug. 19, 2024

(51) Int. Cl. H04L 69/40; H04L 43/0817; H04L 47/125; H04L 61/4511

(52) U.S. Cl. CPC H04L 69/40; H04L 43/0817; H04L 47/125; H04L 61/4511

(57) ABSTRACT

A load balancing and failover load routing scheme is determined including receiving business data associated with data centers. The first data center is identified as non-responsive. The customers associated with the first data center are identified. The customer resource groups are linked to the customers. The responsive data centers with available compute capacity to serve as failover targets are identified. The global rebalance table (GRT) associating the customer resource groups with the responsive data centers with available compute capacity to serve as failover targets is constructed. The optimum load balancing and failover load routing scheme is determined.

### BACKGROUND

The present invention relates generally to load balancing compute resource requests. More particularly, the present invention relates to a method, system, and computer program designed for load balancing and failover routing across data centers located in different geolocations (e.g., region, or a position on the earth).

A load balancer is a process responsible for distributing tasks, such as cloud requests or internet traffic, across a set of compute resources like compute nodes (e.g., computers, servers, or processors) and storage (e.g., disk, ram). This process, known as load balancing, aims to enhance the overall processing efficiency of the data center deploying the set of compute resources. By managing response times and preventing some compute resource from being overloaded, while other compute resources remain idle/standby, load balancing ensures a more balanced and efficient use of compute resources in the data center. As a result, load balancing benefits computing clients (e.g., application clients, end users, customers) with dynamic, reliable, and scalable compute services (e.g., cloud services).

When a load balancer distributes tasks (e.g., workloads, loads, compute resource requests, customer resource groups) among numerous compute resources (e.g., connected servers) dispersed across regional data centers, it is known as a “global load balancer.” Notably, global load balancers are crucial in distributing tasks to other responsive data centers in a region when a non-responsive data center experiences an outage, playing an integral role in disaster recovery (DR). Disaster recovery is the process of maintaining or reestablishing vital compute infrastructure and systems within data centers following a natural, simulated, or human-induced disaster, such as a storm or regional power outage or failure. Disaster recovery employs policies, tools, and procedures known as failover policies. Failover involves implementing failover policies that switch to a redundant or standby compute, such as server, system, hardware component, network, or data center upon the failure or abnormal termination of the previously active compute. For example, if a global load balancer detects that a region, such as the Dallas metropolitan area, is non-responsive due to regional power outage in Texas, the global load balancer executes a failover policy. Then, under the failover policy, the global load balancer facilitates the redirection of cloud traffic to the geographically closest data center, such as to a data center in Fort Worth, Texas.

However, under certain circumstances, typical failover policies may result in overloading and exceeding the available compute capacity of the geographically closest data center, a problem known as the “thundering herd event.” The thundering herd event typically occurs for a cloud service (e.g., a weather service) hosted by the geographically closest data center when a large number of clients or services simultaneously send or retry requests to the cloud service, after a period that the cloud service is unavailable or unstable. If the global load balancer detects that the data center is non-responsive (e.g., slow or offline or overloaded), the global load balancer redirects cloud traffic to the next geographically closest data center according to the typical failover policy, potentially repeating the cycle. Furthermore, if the global load balancer redirects cloud traffic to compute (e.g. servers) in the geographically closest data center in a rotational or round-robin manner, especially without considering whether some computes have more active connections than others, the thundering herd event can lead to a domino scenario where major regional data centers become non-responsive. This could additionally lead to a cascading failure across multiple regional data centers, causing widespread service disruptions or outages for the cloud service.

It would be desirable to have methods, systems, and computer programs designed for optimizing load balancing and disaster recovery failover load routing across geolocations and data centers without exceeding the available compute capacity of each data center that would overcome the above disadvantages.

### SUMMARY

The illustrative embodiments provide for optimizing load balancing and failover routing across data centers located globally. An embodiment includes generating an optimum load balancing and failover load routing scheme during an actual disaster recovery event for a plurality of data centers. The embodiment includes receiving business data associated with the plurality of data centers from a business support services (BSS) metering and billing service. The embodiment includes identifying a first data center, from the plurality of data centers, that is non-responsive, based at least in part on the business data. The embodiment includes identifying one or more customers associated with the first data center. The embodiment includes determining one or more customer resource groups linked the one or more customers. The embodiment includes identifying one or more responsive data centers, from the plurality of data centers, that have available compute capacity to serve as one or more failover targets, based at least in part on the business data. The embodiment includes constructing a global rebalance table (GRT) that associates the one or more customer resource groups with the one or more responsive data centers having available compute capacity to serve as the one or more failover targets. The embodiment includes generating the optimum load balancing and failover load routing scheme based at least in part on the global rebalance table (GRT). Other embodiments of this aspect include corresponding computer systems, apparatus, and computer programs recorded on one or more computer storage devices, each configured to perform the actions of the embodiment.

An embodiment includes a computer usable program product. The computer usable program product includes a computer-readable storage medium, and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of a computing environment in accordance with an illustrative embodiment;

FIG. 2 depicts a flowchart of an example process for optimizing load balancing and failover routing across data centers in accordance with an illustrative embodiment;

FIG. 3 depicts a flowchart of an example simulated process for a KeithTree in accordance with an illustrative embodiment;

FIG. 4 depicts a flowchart of an example real-world process for a KeithTree in accordance with an illustrative embodiment;

FIG. 5 depicts a block diagram of an example KeithTree infrastructure in accordance with an illustrative embodiment;

FIG. 6A depicts a block diagram of an example Global Capacity Balance Before Disaster Recovery Failover in accordance with an illustrative embodiment; and

FIG. 6B depicts a block diagram of an example Global Capacity Balance During/After Disaster Recovery Failover in accordance with an illustrative embodiment.

### DETAILED DESCRIPTION

The present disclosure addresses the deficiencies described above by providing a process (as well as a system, method, machine-readable medium, etc.) for optimizing load balancing and disaster recovery failover load routing across geolocations and data centers without exceeding the available capacity of each data center.

Providing improved functionality to optimize load balancing and disaster recovery failover load routing across geolocations and data centers matters for the following reasons. First, this improved functionality mitigates the risk of cascading failures across multiple regional data centers, which can cause widespread service disruptions or outages due to thundering herd events during disaster recovery. Second, this improved functionality eliminates the need for complex cloud monitoring tools to perform optimization. Third, the improved functionality ensures that sensitive business data is not exposed to global load balancers or manual processes. Disclosed embodiments provide aforementioned advantages/benefits and technological improvements over the existing tools, techniques, and systems for modeling and simulating and optimizing load balancing and disaster recovery failover load routing.

An illustrative overview of an embodiment of the invention is as follows: optimizing the load balancing and disaster recovery failover load routing across data centers in various geolocations, without exceeding the available compute capacity of individual data centers generally comprises five stages: 1) KeithTree, 2) Global Capacity Balancing During Disaster Recovery Failover, 3) Workloads and Failover Targets, 4) Cloud Infrastructure as Code & Global Cloud Data Centers, and 5) Global Service BSS Metering and Billing.

### KeithTree Stage

At the first stage, an embodiment of the invention, referred to as the KeithTree, provides dynamic load balancing across data centers worldwide, during a disaster recovery event or scenario. Receiving business data, metrics, and analytics, collectively referred to as business data, from the Global Service BSS Metering and Billing Stage, the KeithTree may calculate or predict the cloud usage and cost for each data center located globally. The KeithTree may generate business calculations for cloud services and customers, including compute capacity limits, compute availability, cloud usage, cost, and capacity requirements for one or more data centers. Additionally, based upon these business calculations (as well as business data), the KeithTree may output or generate an optimized or optimum failover routing scheme (e.g., Global Re-Balance Table (GRT)) and deployable architecture or template (e.g., Infrastructure as Code) in real-time to achieve a global load balancing for disaster recovery during an outage of one or more data centers. It should be noted that KeithTree's approach to monitoring of business data and analytics involves centralizing of sensitive business calculation and sharing only the failover routing schemes and deployable architecture or templates with global load balancers. This ensures that sensitive data regarding individual data centers and customers is obfuscated, maintaining the confidentiality of proprietary data and trade secrets. In some embodiments, the KeithTree may be used to simulate or model a disaster recovery event or scenario for cloud testing purposes. In other embodiments, the KeithTree may be deployed to facilitate disaster recovery during real-world disaster events or scenarios.

### Global Capacity Balancing During Disaster Recovery Failover Stage

At the second stage, the global compute capacity across data centers located worldwide is assessed. The second stage may produce the compute capacity limits and compute availability for each data center (e.g., business calculations), including cloud usage, cost, and capacity requirements for cloud services and customers. Additionally, business calculations in this stage may include projections for compute capacity projections in failover scenarios. In some embodiments, the second stage is integrated into the first stage, as a series of method steps.

### Workloads and Failover Targets Stage

At the third stage, a table known as the Global Rebalance Table (GRT) may be compiled, identifying workloads to be assigned to target data centers as failovers, based on the output of the second stage. The GRT may include details such as the workload name, workload ID, name of the failover target data center, and the current operational status of the target data center (e.g., responsive, active). In some embodiments, the third stage may be integrated into the first or second stage as a series of method steps.

### Cloud Infrastructure as Code and Global Cloud Data Centers

At the fourth stage, a deployable architecture (e.g., cloud infrastructure as code component) is generated based on the Global Rebalance Table (GRT) output from the third stage. This deployable architecture may be in the form of a template (e.g., deployable architecture template), such as a Terraform template, which is executable when uploaded into a Cloud Infrastructure as Code platform or cloud catalog. Specifically, the Terraform template, when deployed, creates cloud infrastructure and restore cloud services. Furthermore, when the deployable architecture is deployed on a Cloud Infrastructure as Code platform or cloud catalog, global load balancers direct the target data centers to assume the workloads (e.g., customer resource groups) outlined in the GRT. These target data centers then report newly modified business data and metrics to the Global Service BSS Metering and Billing Stage. In some embodiments, the fourth stage is integrated into the first, second, or third stage as a series of method steps.

### Global Service BSS Metering and Billing Stage

At the fifth stage, reported business data, metrics, and analytics from globally located data centers and load balancers are received. Reported business data, metrics, and analytics (collectively referred to as business data) may include details such as customer group resources, customer account information, customer names, customer IDs, cloud usage, capacity, and cost, and any other data or type of service (e.g., storage, processing, bandwidth, and active user accounts) needed to facilitate the operation of the system, component or method. Additionally, the reported and compiled business data, metrics, and analytics are fed into the other stages. Although the five stages described above were described in a specific order, it should be understood that other stages may be performed among the five stages or may be performed in an order other than that described, or stages may be adjusted so that they occur at slightly different times.

The following description provides examples of embodiments of the present disclosure, and variations and substitutions may be made in other embodiments. Several examples will now be provided to further clarify various aspects of the present disclosure.

### Example 1

A computer-implemented method generating an optimum load balancing and failover load routing scheme during an actual disaster recovery event for a plurality of data centers that comprises receiving business data associated with the plurality of data centers from a business support services (BSS) metering and billing service. The method further comprises identifying a first data center, from the plurality of data centers, that is non-responsive, based at least in part on the business data. The method further comprises identifying one or more customers associated with the first data center. The method further comprises determining one or more customer resource groups linked the one or more customers. The method further comprises identifying one or more responsive data centers, from the plurality of data centers, that have available compute capacity to serve as one or more failover targets, based at least in part on the business data. The method further comprises constructing a global rebalance table (GRT) that associates the one or more customer resource groups with the one or more responsive data centers having available compute capacity to serve as the one or more failover targets. The method further comprises generating the optimum load balancing and failover load routing scheme based at least in part on the global rebalance table (GRT).

The above limitations enable the determination of an optimal load balancing and failover load routing scheme. This scheme can be effectively employed during actual disaster recovery scenarios to reduce the risk of cascading failures across multiple regional data centers, which could otherwise lead to widespread service disruptions or outages due to thundering herd events. Additionally, the optimal load balancing and failover load routing scheme eliminates the need for complex cloud monitoring tools to optimize load balancing and failover routing, as business data, used as a proxy for data center performance and operation, is already collected and utilized for business and operational purposes. Eliminating the need for complex cloud monitoring tools and reducing the reliance on manual processes further leads to significant cost savings in both infrastructure and labor. Furthermore, the method ensures that sensitive business data is protected from exposure to global load balancers or manual processes, as it is securely stored in centralized locations with robust security management capabilities. This secure storage supports compliance with data protection regulations and privacy laws, particularly in jurisdictions with strict requirements. The method also streamlines disaster recovery planning and execution, enabling faster service restoration and minimizing the impact on business operations during unforeseen events. Aspects of the present disclosure improve the load balancing and failover routing process by accurately detecting the degradation (e.g., non-responsiveness) of one or more regional data centers and efficiently identifying alternative failover data centers for the affected customers and services.

### Example 2

The limitations of Example 1, where the receiving business data further comprises one or more of the following: a revenue, a billed usage, a revenue potential, business analytics, production capacity limits, a data center availability, a customer account, and a customer workload.

The above limitations advantageously facilitate the identification of business data types used to assess whether a first data center is non-responsive and to determine which other global data centers are responsive with available compute capacity to serve as failover targets. By leveraging specific business data types for this identification, the improved method can more accurately locate suitable failover data centers, enhancing the reliability of the failover process. Furthermore, precise identification of responsive data centers with adequate capacity reduces the risk of failover failures, which could occur if the failover targets are not properly equipped to handle the load. Aspects of the present disclosure improve decision-making regarding data center performance and failover strategy by employing targeted business data types, promoting more informed and data-driven decisions.

### Example 3

The limitations of Example 1, further includes outputting a deployable architecture template based, at least in part, on the optimal load balancing and failover load routing scheme. The above limitations advantageously enhance reliability by deploying an architecture template, based on an optimal load balancing and failover scheme, promotes effective management and redirection of data center traffic to maintain continuous service availability. Additionally, the above limitations advantageously maintain security and compliance by ensuring that failover processes and resource allocations are handled securely and efficiently by the deployable architecture template.

### Example 4

The limitations of Examples 1 and 3, where the deployable architecture template is a Cloud Infrastructure as Code (IaC) component. The above limitations advantageously enable automatic provisioning and management of cloud infrastructure through code, reducing the need for manual configuration and minimizing human error. As a result, automated infrastructure provisioning and management accelerate deployment times, shortening the overall time to market for new applications or updates. Users can define cloud resources and infrastructure configurations using high-level, human-readable code or scripts, which specify the desired state of the infrastructure rather than the specific steps to achieve it. Additionally, including the Cloud Infrastructure as Code (IaC) component optimizes resource usage and costs by providing tools for effective management and monitoring of cloud resources, potentially leading to cost savings through more efficient resource allocation.

### Example 5

The limitations of Example 4, further includes uploading the deployable architecture template into a Cloud catalog. The above limitations advantageously enable storing the deployable architecture template in a cloud catalog provides a centralized repository, making the deployable architecture template accessible and manageable by authorized users across different teams and geolocations. This availability simplifies and accelerates the deployment process, allowing users to quickly retrieve and deploy the deployable architecture template without needing to manually recreate the deployable architecture template. Additionally, the above limitations promote that the most up-to-date and standardized version of the deployable architecture template is used, reducing the risk of discrepancies or outdated configurations. Cloud catalogs typically support versioning, which helps users manage different versions of the architecture template and track changes over time, facilitating easier rollbacks and updates. Deployable architecture templates stored in a cloud catalog can be reused across multiple projects or environments, enhancing efficiency and consistency in deploying similar architectures. Furthermore, having deployable architecture template in a cloud catalog supports disaster recovery planning by enabling restoration or redeployment of deployable architecture templates if needed.

### Example 6

The limitations of Example 1, where the association between the one or more customer resource groups with the one or more responsive data centers that have available compute capacity to serve as the one or more failover targets is further based on a prioritization of the one or more customer resource groups by customer. The above limitations advantageously allow the method to prioritize critical customer resource groups, ensuring that the most important services and clients experience minimal disruption during a failover, thereby maintaining service continuity for key operations. By allocating available compute capacity to the most critical or high-priority customer resource groups first, this method ensures efficient and effective use of limited resources during failover scenarios. Additionally, prioritizing customer resource groups helps ensure compliance with service level agreements (SLAs) and regulatory requirements, as critical services are given precedence in failover scenarios, aiding in meeting legal and contractual obligations. This prioritization also streamlines the recovery process, ensuring that the most critical systems are restored first, leading to faster overall recovery times and minimizing downtime for essential services.

### Example 7

The limitations of Example 4, where the deployable architecture template further includes a code to dynamically configure one or more Domain Name Service (DNS) resolvers. The above limitations advantageously allow the deployable architecture to adapt to changing network conditions and requirements, offering greater flexibility in managing Domain Name Service (DNS) settings without manual intervention. By automating Domain Name Service (DNS) resolver configuration, the system supports efficient scaling of the infrastructure, simplifying the addition or removal of Domain Name Service (DNS) resolvers as the method grows or contracts.

### Example 8

A computer usable program product comprising one or more computer readable storage media, and program instructions collectively stored on the one or more computer readable storage media to perform the method according to any of Examples 1-7. The computer program product of Example 8 realizes the benefits described with respect to Examples 1-7. The computer program product of Example 8 can advantageously be implemented into a variety of computer program products.

### Example 9

The limitations according to Example 8, where the receiving business data further comprises one or more of the following: a revenue, a billed usage, a revenue potential, business analytics, production capacity limits, a data center availability, a customer account, and a customer workload. The above limitations realize the technical advantages discussed with respect to Example 2.

### Example 10

The limitations according to Example 8, where further includes outputting a deployable architecture template based, at least in part, on the optimum load balancing and failover load routing scheme. The above limitations realize the technical advantages discussed with respect to Example 3.

### Example 11

The limitations according to Examples 8 and 10, where the deployable architecture template is a Cloud Infrastructure as Code (IaC) component. The above limitations realize the technical advantages discussed with respect to Examples 3 and 4.

### Example 12

The limitations according to Example 11, where further uploading the deployable architecture template into a Cloud catalog. The above limitations realize the technical advantages discussed with respect to Example 5.

### Example 13

The limitations according to Example 8, where the association between the one or more customer resource groups with the one or more responsive data centers that have available compute capacity to serve as the one or more failover targets is further based on a prioritization of the one or more customer resource groups by customer. The above limitations realize the technical advantages discussed with respect to Example 6.

### Example 14

The limitations according to Example 11, the deployable architecture template further includes a code to dynamically configure one or more Domain Name Service (DNS) resolvers. The above limitations realize the technical advantages discussed with respect to Example 7.

### Example 15

A system comprising one or more processors and one or more computer-readable storage media collectively storing program instructions which, when executed by the one or more processors, are configured to cause the one or more processors to perform the method according to any of Examples 1-7. The system of Example 8 realizes the benefits described with respect to Examples 1-7. The system of Example 8 can advantageously be implemented into a variety of computing devices.

### Example 16

The limitations according to Example 15, where the receiving business data further comprises one or more of the following: a revenue, a billed usage, a revenue potential, business analytics, production capacity limits, a data center availability, a customer account, and a customer workload. The above limitations realize the technical advantages discussed with respect to Example 2.

### Example 17

The limitations according to Example 15, where further includes outputting a deployable architecture template based, at least in part, on the optimum load balancing and failover load routing scheme. The above limitations realize the technical advantages discussed with respect to Example 3.

### Example 18

The limitations according to Example 17, where the deployable architecture template is a Cloud Infrastructure as Code (IaC) component. The above limitations realize the technical advantages discussed with respect to Examples 3 and 4.

### Example 19

The limitations according to Example 18, where further uploading the deployable architecture template into a Cloud catalog. The above limitations realize the technical advantages discussed with respect to Example 5.

### Example 20

The limitations according to Example 15, where the association between the one or more customer resource groups with the one or more responsive data centers that have available compute capacity to serve as the one or more failover targets is further based on a prioritization of the one or more customer resource groups by customer. The above limitations realize the technical advantages discussed with respect to Example 6.

### Example 21

A computer-implemented method generating an optimum load balancing and failover load routing scheme during a stimulated disaster recovery event for a plurality of data centers that comprises receiving business data associated with the plurality of data centers from a business support services (BSS) metering and billing service. The method further comprises identifying a first data center, from the plurality of data centers, that is non-responsive, based at least in part on the business data. The method further comprises identifying one or more customers associated with the first data center. The method further comprises determining one or more customer resource groups linked the one or more customers. The method further comprises identifying one or more responsive data centers, from the plurality of data centers, that have available compute capacity to serve as one or more failover targets, based at least in part on the business data. The method further comprises constructing a global rebalance table (GRT) that associates the one or more customer resource groups with the one or more responsive data centers having available compute capacity to serve as the one or more failover targets. The method further comprises generating the optimum load balancing and failover load routing scheme based at least in part on the global rebalance table (GRT).

The above limitations enable the determination of an optimal load balancing and failover load routing scheme. This scheme is particularly effective during simulated disaster recovery scenarios, as it reduces the risk of cascading failures across multiple regional data centers, which could otherwise lead to widespread service disruptions or outages due to thundering herd events. By simulating disaster recovery events, this method ensures that the system is well-prepared for real-world situations, proactively minimizing downtime and enabling a smooth transition during actual disaster events. Additionally, the optimal load balancing and failover load routing scheme eliminates the need for complex cloud monitoring tools to optimize load balancing and failover routing, as business data, used as a proxy for data center performance and operation, is already collected and utilized for business and operational purposes. Eliminating the need for complex cloud monitoring tools and reducing the reliance on manual processes further leads to significant cost savings in both infrastructure and labor. Furthermore, the method ensures that sensitive business data is protected from exposure to global load balancers or manual processes, as it is securely stored in centralized locations with robust security management capabilities. This secure storage supports compliance with data protection regulations and privacy laws, particularly in jurisdictions with strict requirements. The method also streamlines disaster recovery planning and execution, enabling faster service restoration and minimizing the impact on business operations during unforeseen events. Aspects of the present disclosure improve the load balancing and failover routing process by accurately detecting the degradation (e.g., non-responsiveness) of one or more regional data centers and efficiently identifying alternative failover data centers for the affected customers and services.

### Example 22

The limitations of Example 21, where the receiving business data further comprises one or more of the following: a revenue, a billed usage, a revenue potential, business analytics, production capacity limits, a data center availability, a customer account, and a customer workload.

The above limitations advantageously facilitate the identification of business data types used to assess whether a first data center is non-responsive and to determine which other global data centers are responsive with available compute capacity to serve as failover targets. By leveraging specific business data types for this identification, the improved method can more accurately locate suitable failover data centers, enhancing the reliability of the failover process. Furthermore, precise identification of responsive data centers with adequate capacity reduces the risk of failover failures, which could occur if the failover targets are not properly equipped to handle the load. Aspects of the present disclosure improve decision-making regarding data center performance and failover strategy by employing targeted business data types, promoting more informed and data-driven decisions.

### Example 23

The limitations of Example 21, further includes outputting a deployable architecture template based, at least in part, on the optimal load balancing and failover load routing scheme. The above limitations advantageously enhance reliability by deploying an architecture template, based on an optimal load balancing and failover scheme, promotes effective management and redirection of data center traffic to maintain continuous service availability. Additionally, the above limitations advantageously maintain security and compliance by ensuring that failover processes and resource allocations are handled securely and efficiently by the deployable architecture template.

### Example 24

The limitations of Examples 21 and 23, where the deployable architecture template is a Cloud Infrastructure as Code (IaC) component. The above limitations advantageously enable automatic provisioning and management of cloud infrastructure through code, reducing the need for manual configuration and minimizing human error. As a result, automated infrastructure provisioning and management accelerate deployment times, shortening the overall time to market for new applications or updates. Users can define cloud resources and infrastructure configurations using high-level, human-readable code or scripts, which specify the desired state of the infrastructure rather than the specific steps to achieve it. Additionally, including the Cloud Infrastructure as Code (IaC) component optimizes resource usage and costs by providing tools for effective management and monitoring of cloud resources, potentially leading to cost savings through more efficient resource allocation.

### Example 25

A computer usable program product comprising one or more computer readable storage media, and program instructions collectively stored on the one or more computer readable storage media to perform the method according to any of Examples 21-24. The computer program product of Example 25 realizes the benefits described with respect to Examples 21-24. The computer program product of Example 25 can advantageously be implemented into a variety of computer program products.

Aspects of the present disclosure can be implemented in a variety of technical use cases. The following use cases are merely exemplary and are not intended to limit the scope of the disclosure.

In a first use case, IBM Cloud® and Akamai® Load Balancers can be utilized by leveraging IBM Cloud's data management and analytics services to gather and analyze business data related to data center performance. IBM Cloud's monitoring tools identify non-responsive data centers, while Akamai's performance monitoring provides additional insights into traffic disruptions. Next, IBM Cloud's resource management tools are used to group affected customers and resources, and identify responsive data centers with available compute capacity. The Global Rebalance Table (GRT) is then constructed using IBM Cloud's database services, incorporating insights from Akamai's performance metrics. Finally, the optimal load balancing and failover routing scheme is generated using IBM Cloud's load balancing services and Akamai's Global Traffic Management to ensure effective traffic distribution and failover routing. Integrating data from both platforms into a unified dashboard and automating routing decisions will streamline the process and enhance system resilience. This approach addresses the complications associated with generating an optimal load balancing and failover routing scheme during an actual or simulated disaster recovery event for a plurality of data centers, as exemplified in Examples 1-25 discussed above.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefore, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

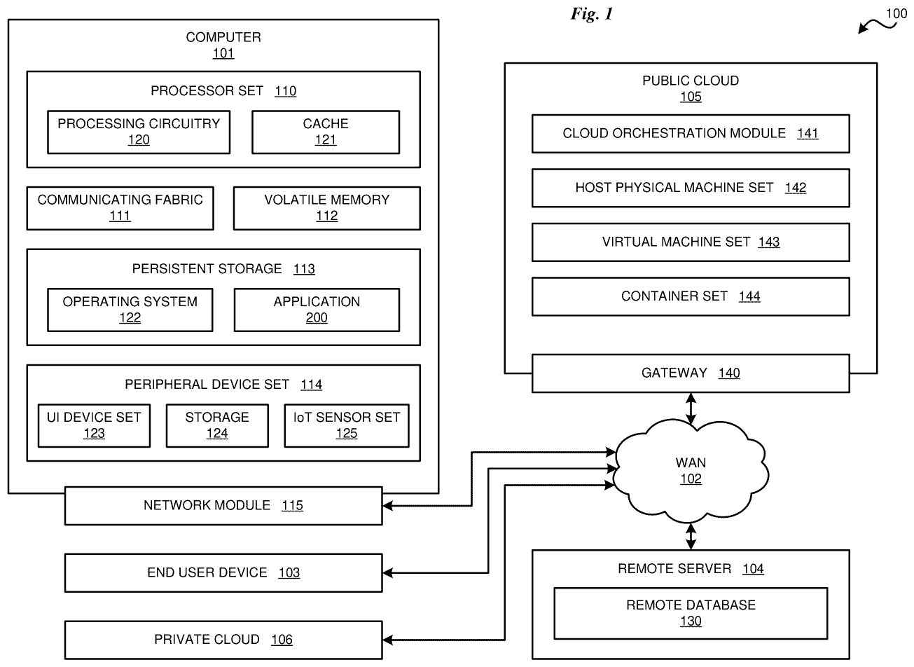

With reference to FIG. 1, this figure depicts a block diagram of a computing environment 100. Computing environment 100 contains an example of an environment for the execution of at least some computer code involved in performing the inventive methods, such as an example application 200 for load balancing and failover routing across data centers located in different geolocations. The following are definitions for terms used throughout the disclosure. “Geolocation” is a term used in the present disclosure to describe a geographical or physical location or position, coordinates (e.g., latitude and longitude), a region, a state, an address or a country. “Geolocation” may be obtained as data from various sources, including but not limited to GPS (Global Positioning System), Wi-Fi networks, IP addresses, and cellular networks. “Deployable Architecture” is a term used in the present disclosure to describe a structured design and configuration of a system or solution that is prepared for implementation and operational use in a production environment (e.g., a data center or load balancer or cloud computer environment). A “deployable architecture” may include all the necessary components, such as hardware, software, network configurations, and deployment procedures, to ensure that the “deployable architecture” can be installed, integrated, and used within the intended operational context. A “deployable architecture” may be designed to meet or exceed the performance, scalability, reliability, and security requirements of the operational environment. The term “deployable architecture” may be used interchangeably with the term “deployable architecture template”; “Load Balancing and Failover Load Routing Scheme” is a term used in the present disclosure to describe a planned or structured approach, method, or strategy for distributing network traffic, compute tasks or workloads across one or more servers, data centers, or resources to promote the performance, reliability, and availability of an operational environment (e.g., a data center or load balancer or cloud computer environment); The term “Load Balancing and Failover Load Routing Scheme” may be used interchangeably with the terms “Load Balancing and Failover Load Routing” and “Scheme”; “Load balancing” is a term used in the present disclosure to describe a dynamic process or method for distributing workloads across one or more servers, data centers, or resources to prevent any single servers, data centers, or resources from becoming a bottleneck; “Failover Load Routing” is a term used in the present disclosure to describe a dynamic process or method for redirecting traffic, tasks, or workloads from a failing or degraded server or data center to a backup or alternative server, data center, or resource to promote continuous service availability; “Disaster Recovery” or “DR” is a term used in the present disclosure to describe one or more processes, strategies, and actions designed to restore and maintain critical business functions and IT systems (e.g., data centers, servers, cloud computing infrastructure) following a disruptive or unexpected event, scenario, incident, outage, failure, or disaster. “Disaster Recovery scenario” or “DR scenario” is a term used in the present disclosure to describe a hypothetical, modeled, simulated, or actual situation or event in which an organization must implement or execute one or more disaster recovery plans to address and manage the impact of disruptive or unexpected event, scenario, incident, outage or disaster. The term “Disaster Recovery scenario” may be used interchangeably with the terms “Disaster Recovery event,” “Disaster Recovery outage,” “failover scenario,” “outage,” “failure” or “Disaster Recovery incident”; “Non-Responsive” is a term used in the present disclosure to describe a state or condition where a system (e.g., data centers, servers, cloud computing infrastructure), component, or entity fails to react, acknowledge, or provide a required response to requests, inputs, or interactions within an expected or appropriate timeframe, or period, or time; The term “Non-Responsive” may be used interchangeably with terms “slow,” “inactive,” “unavailable,” “offline,” “outage,” “failure,” or “overloaded”; “Responsive” is a term used in the present disclosure to describe state or condition where a system (e.g., data centers, servers, cloud computing infrastructure), component, or entity actively and/or promptly reacts to requests, inputs, or interactions, providing the required responses or actions within an expected or appropriate timeframe, or period, or time; the term “Responsive” may be used interchangeably with the term “active”; “Cloud Infrastructure as Code (IaC) Component” is a term used in the present disclosure to describe a specific element or tool within a broader Cloud Infrastructure as Code (IaC) framework that facilitates the automated management and provisioning of cloud infrastructure resources through code; “Cloud Catalog” is a term used in the present disclosure to describe a centralized repository or service that provides access to a collection of cloud resources, templates, services, and configurations which can be deployed across one or more servers, data centers, resources, or cloud computing infrastructure; “Failover Target” is a term used in the present disclosure to describe a backup or secondary system, component, server, data center, or resource that automatically takes over operations when the primary system, component, server, data center, or resource fails or becomes unavailable; the term “Failover Target” may be used interchangeably with the terms “Failover assignment,” or “failover”; “Cloud Usage” is a term used in the present disclosure to describe the amount of resources or compute consumed or utilized by one or more customers within a cloud computing environment (e.g., data center); “Cloud Usage” may include various metric, charges, or cost such as CPU usage, memory consumption, storage space, network bandwidth, computing power, data transfer, and the number of virtual machines or services in use or other cloud services as billed by the cloud service provider; “loud Usage” may vary based on the type and amount of resources used, the pricing model (e.g., pay-as-you-go, reserved instances), and any additional services or features employed; the term “Cloud Usage” may be used interchangeably with the term “Cloud Cost”; “KeithTree” is a term used in the present disclosure to describe a method, component, system or platform designed for dynamic load balancing, failover routing and/or disaster recovery management in cloud environments (e.g., data centers); “Customer Resource Group” is a term used in the present disclosure to describe a collection or grouping of resources, compute resources, services, and assets that are organized and managed together for a specific customer or client within a cloud computing environment, data center, or enterprise IT system; the term “Customer Resource Group” may be used interchangeably the term “workload”; the term “Global Rebalance Table (GRT)” is used in the present disclosure to describe a data structure or compute code used in distributed computing environments (e.g., data center, cloud computing infrastructure), particularly in the context of load balancing, failover routing and disaster recovery; “Global Rebalance Table” or “GRT” may be used to compile and organize information about workloads or customer resource groups that need to be reassigned to different data centers in the event of a failover or rebalancing operation; “Business Calculations” is a term used in the present disclosure to describe estimations and analyses related to cloud resource usage costs, capacity needs for failover scenarios, and future requirements based on anticipated growth and usage patterns; The term “Business Calculations” may include evaluating capacity limits and availability, analyzing cloud usage and costs, and projecting compute capacity requirements in failover scenarios;

In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.” References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

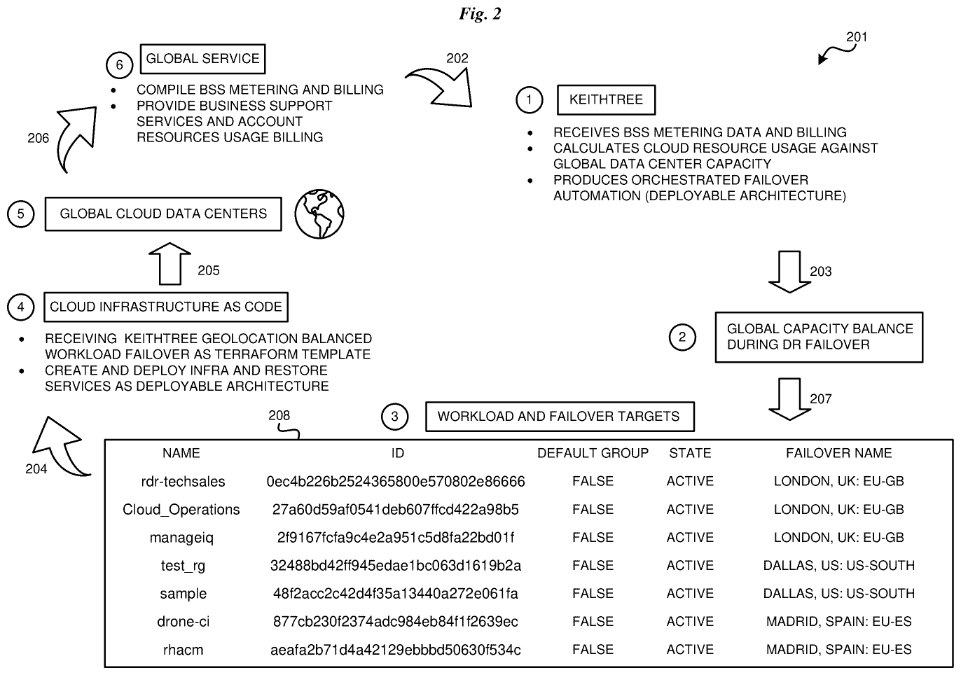

With reference to FIG. 2, this figure depicts flowchart diagram 201 for optimizing load balancing and failover routing across data centers in accordance with an illustrative embodiment. In the illustrated embodiment, the flowchart diagram 201 includes KeithTree module (1), curved arrow 203, Global Capacity Balancing during Disaster Recovery Failover module (2), straight arrow 207, Workloads and Failover Targets module (3), curved arrow 204, Cloud Infrastructure as Code module (4), curved arrow 205, Global Cloud Data Centers module (5), straight arrow 206, Global Service BSS Metering and Billing module (6), and curved arrow 202. Arrows 202-206 illustrate the flow of data or information among the modules of the illustrated flowchart diagram. KeithTree module (1) provides dynamic load balancing across data centers worldwide, during a disaster recovery event or scenario. Receiving business data, metrics, and analytics 202 (e.g., metering and billing data) from the Global Service BSS Metering and Billing module (5), the KeithTree module (1) may calculate or predict the cloud usage and cost for data centers located globally. The KeithTree module (1) may produce compute capacity limits and compute availability for one or more data centers (e.g., business calculations), including cloud usage, cost, and capacity requirements for cloud services and customers. Additionally, based upon these business calculations, the Keithtree module (1) may output an optimized load balancing and/or failover routing scheme (e.g., Global ReBalance Table (GRT)) 203 and deployable architecture or template (e.g., Infrastructure as Code compone) 203 in real-time to achieve a global load balancing for disaster recovery during an outage of one or more data centers. In some embodiments, the KeithTree module (1) may be used to simulate or model a disaster recovery event or scenario for cloud testing purposes. In other embodiments, the KeithTree module (1) may be deployed to facilitate disaster recovery during real-world disaster events or scenarios.

Global Capacity Balancing during Disaster Recovery Failover module (2) assesses the global compute capacity across data centers located worldwide based on the output 203 of KeithTree module (1) (or output from Global Service BSS Metering and Billing module (5)). In some embodiments, Global Capacity Balancing during Disaster Recovery Failover module (2) can generate compute capacity limits and availability 207, including cloud usage, cost, and capacity requirements (e.g., business calculations) for cloud services and customers across one or more global cloud data centers (5). Additionally, these capacity limits and availability 207 (e.g., business calculations) in this stage may include projections for compute capacity projections in failover scenarios. In some embodiments, Global Capacity Balancing during Disaster Recovery Failover module (2) is integrated into KeithTree module (1), as a series of method steps or one or more components.

Workloads and Failover Targets module (3) may compile the Global Rebalance Table (GRT) 208, identifying workloads to be assigned to target data centers (e.g., public clouds 105a-105d) as failovers, based on the output 207 of Global Capacity Balancing during Disaster Recovery Failover module (2). Additionally, Workloads and Failover Targets module (3) generates Global Rebalance Table (GRT) 208 as output 204. Global Rebalance Table (GRT) 208 may include details such as the workload name (e.g., name), workload ID (e.g., id), default group, current operational state (status or state) of the target data center (e.g., active, responsive, or inactive), and name of the failover target data center (e.g., failover name). In some embodiments, Workloads and Failover Targets module (3) may be integrated into the KeithTree module (1) or Global Capacity Balancing during Disaster Recovery Failover module (2), as a series of method steps or one or more components.

Cloud Infrastructure as Code module (4) generates one or more deployable architectures (e.g., cloud infrastructure as code) based on Global Rebalance Table (GRT) 208 produced as output 204 from Workloads and Failover Targets module (3). A deployable architecture may be in the form of a template, such as a Terraform template, which becomes executable when uploaded to a Cloud Infrastructure as Code platform. Specifically, the Terraform template, when deployed, creates cloud infrastructure and restore cloud services. In some embodiments, Cloud Infrastructure as Code module (4) may be integrated into the KeithTree module (1), Global Capacity Balancing during Disaster Recovery Failover module (2), or Workloads and Failover Targets module (3), as a series of method steps or one or more components.

Global Cloud Data Centers module (5) is where the deployable architecture 205 (produced as output) is deployed on Cloud Infrastructure as Code platforms (not shown). Global load balancers (not shown) are then instructed to direct the target data centers (e.g., public clouds 105a-105d) to take on (or assume) the workloads (e.g., customer resource groups) specified in the Global Rebalance Table (GRT) 208. These target data centers then report newly modified business data and metrics 206 (as output) to the Global Service BSS Metering and Billing module (6). In some embodiments, Global Cloud Data Centers module (5) may be integrated into the KeithTree module (1), Global Capacity Balancing during Disaster Recovery Failover module (2), Workloads and Failover Targets module (3) or Cloud Infrastructure as Code module (4), as a series of method steps or one or more components.

Global Service BSS Metering and Billing module (6) receives reported business data, metrics, and analytics 206 from Global Cloud Data Centers module (5) (e.g., globally located data centers and load balancers). Reported business data, metrics, and analytics 206 may include details such as customer group resources, customer account information, customer names, customer IDs, cloud usage, capacity, and cost, and any other data or type of service (e.g., storage, processing, bandwidth, and active user accounts) needed to facilitate the operation of the system or method disclosure herein. Additionally, the reported and compiled business data, metrics, and analytics 202 are fed into the other modules (e.g., KeithTree module (1)). Although the six modules described above were described in a specific order, it should be understood that other modules may be performed among the six modules or may be performed in an order other than that described, or modules may be adjusted so that they occur at slightly different times.

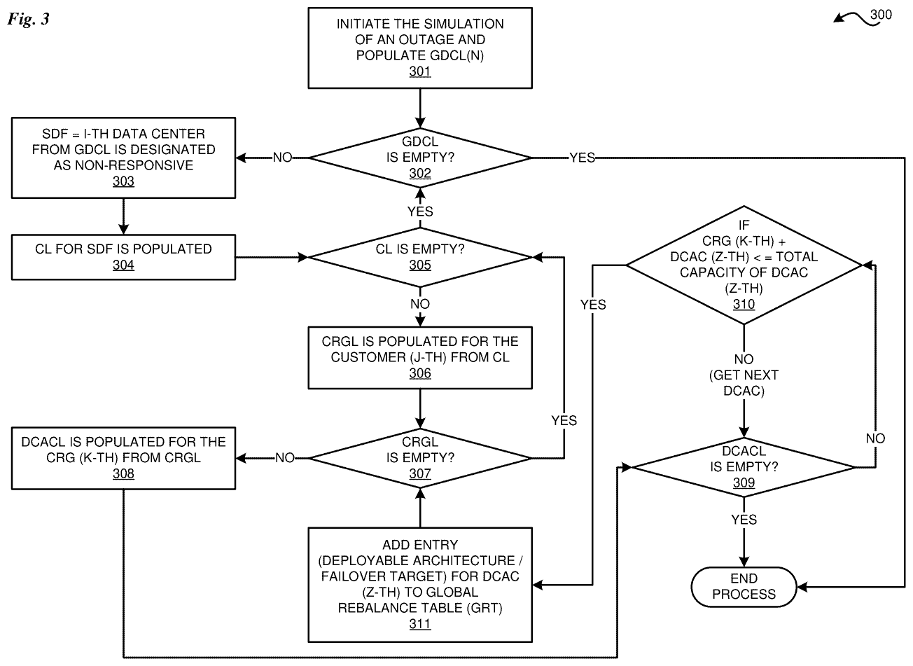

With reference to FIG. 3, this figure depicts a flowchart diagram of a KeithTree embodiment according to KeithTree Service 300. It should be noted that the KeithTree Service 300 can be regarded as an instance of the KeithTree Stage or the KeithTree module (1) mentioned earlier. KeithTree Service 300 aims to enhance the reliability of global data centers by preparing for potential disruptions and ensuring a smooth transition during any simulated outage scenarios. In the illustrated embodiment, KeithTree Service 300 is depicted as a decision-making framework with nodes and decision loops, associated with a simulated disaster recovery event (or outage). KeithTree Service 300 encompasses a range of functionalities, including managing simulated outages and identifying appropriate simulated failover targets for one or more data centers. These simulated failover targets are determined based on the specific resource groups designated by customers (e.g., customer resource group), ensuring that the failover process is designed to meet the unique requirements and configurations of a particular client or customer.

Step 301 initiates the simulation of an outage using a KeithTree decision-making process as per the illustrated embodiment for KeithTree Service 300. At step 301, a Global Data Center List (GDCL), which includes all data centers worldwide, is populated. The length of the GDCL, denoted as N, corresponds to the number of data centers included. During the execution of the KeithTree Service 300 process, each data center in the GDCL is sequentially visited, according to the data center's position in the list, until the list is exhausted. For step 301, after the GDCL is populated, the process proceeds to step 302. Additionally, in some embodiments, the process may be repeated in a continuous loop (i.e., executing steps 301) based on the configurable frequency (e.g., administrator or user-specified intervals of a weeks, days, hours).

At step 302, the Global Data Center List (GDCL) is checked for exhaustion (i.e., whether it is empty or all data centers have been visited). If the GDCL is exhausted, the process ends. Otherwise, the process proceeds to step 303.

At step 303, the i-th data center (i.e., current data center being visited) from the GDCL is designated as non-responsive, simulating an outage or failure. The i-th data center is then referred to as the Simulated Data Center Failure (SDF). The process then moves to step 304.

At step 304, a Customer List (i.e., CL) associated with the Simulated Data Center Failure (SDF) is populated. The Customer List (i.e., CL) includes all customers hosting services in the SDF. Each customer (j-th) in the CL is sequentially visited, according to the customer's position in the list, until the list is exhausted. Additionally, in some embodiments, the CL is prioritized, with higher-priority customers being assigned failover targets first (or visited first) in a later compiled table known as the Global Rebalance Table (GRT). For step 304, after the CL is populated, the process moves to step 305.

At step 305, the Customer List (i.e., CL) is checked for exhaustion (i.e., whether it is empty or all customers have been visited). If the CL is exhausted, the process returns to step 302 to visit the next data center in the Global Data Center List (GDCL). Otherwise, the process proceeds to step 306.

At step 306, a Customer Resource Group List (CRGL) associated with a j-th customer from the Customer List (i.e., CL) is populated. The CRGL includes all customer resource groups associated with the specific customer (j-th customer) in the current iteration of step 306. Each customer resource group (k-th) in the CRGL is sequentially visited according to the customer resource group's position in the list, until the list is exhausted. A customer resource group is a conceptual collection of resources required to operate a cloud service for a specific customer at a particular data center. Additionally, a customer resource group includes the costs associated with cloud usage or metering in the respective data center, as well as user rights assignments for the customer resource group. For step 306, after the CRGL is populated, the process moves to step 307.

At step 307, the Customer Resource Group List (CRGL) is checked for exhaustion (i.e., whether it is empty or all customer resource groups have been visited). If the CRGL is exhausted, the process returns to step 305 to visit the next customer in the Customer List (i.e., CL). Otherwise, the process proceeds to step 308.

At step 308, a Data Centers with Available Capacity List (DCACL) is populated for the k-th customer resource group (CRG) from the Customer Resource Group List (CRGL), for the j-th customer in the Customer List (CL), and for the i-th data center designated as the Simulated Data Center Failure (SDF). The DCACL includes all data centers worldwide that have available compute capacity. In some embodiments, the DCACL is prioritized based on geographic proximity, giving higher priority to data centers that are closer to the SDF. Each data center (z-th or DCAC) in the DCACL is sequentially visited, according to the data center's position in the list, until the list is exhausted or another condition is met. The DCACL does not include the SDF itself. Once a data center is designated as the SDF, it is permanently excluded from the DCACL until the simulation process of the KeithTree Service 300 is restarted or reinitiated.

At step 309, the Data Centers with Available Capacity List (DCACL) is checked to determine if the list is exhausted (i.e., whether the list is empty or all data centers with available capacity (DCAC) have been visited in the list). If the DCACL is exhausted and no data centers with available capacity remain to serve as failover targets for one or more customer resource groups, an alert indicating “no available capacity” (not shown) is sent to the relevant cloud providers for those customer resource groups (in some embodiments), and the process ends. Otherwise, the process proceeds to step 310 with the current data center with available capacity designed as DCAC z-th.

At step 310, for the z-th data center in the DCACL, it is assessed whether the data center with available capacity (DCAC) has sufficient compute capacity to serve as a failover target for the k-th customer resource group (CRG). This determination involves calculating whether the current data center (DCAC z-th) can adequately support the CRG k-th. Specifically, if the sum of the cloud usage cost for the CRG k-th and the current or projected cloud usage cost of the data center DCAC z-th is less than or equal to the total compute capacity cost of DCAC z-th or a predetermined threshold, then DCAC z-th may be considered a suitable failover target. The relevant mathematical equation is as follows: Customer Resource Group Cloud Usage Cost+Data Center Current/Projected Cloud Usage Cost ¿=Data Center Total Compute Capacity Cost.

Continuing with step 310, if the condition specified by the relevant mathematical equation is satisfied (i.e., if the sum is less than or equal to the total capacity), the process proceeds to step 311, where an entry is added to the Global Rebalance Table (GRT) (or to a deployable architecture template) indicating that the current data center (DCAC z-th) is designated as the failover target for the k-th customer resource group (CRG). Additionally, the available capacity of DCAC z-th in the DCACL is reduced by the cloud usage cost of the CRG k-th. This reduction remains in effect until the simulation process of the KeithTree Service 300 is restarted or reinitiated. The process then returns to step 307 to evaluate the next customer resource group from the Customer Resource Group List (CRGL).

Alternatively, at step 301, if the above condition (i.e., relevant mathematical equation) is not met (i.e., the sum exceeds total capacity or no), the process then returns to step 309 to evaluate the next data center (DCAC) in DCACL.

At step 311, the Global Rebalance Table (GRT) is made available to customers and other embodiments through API (Application Program Interface) calls. The GRT contains information on the simulated failover targets for each resource group across all data center failure scenarios. The GRT can be used as input for deployment architectures.

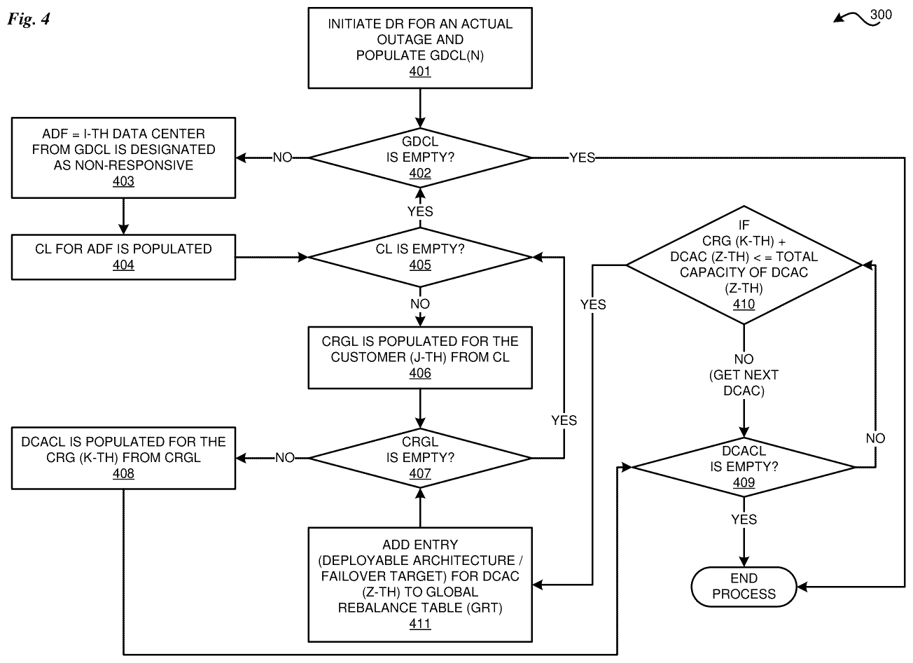

With reference to FIG. 4, this figure depicts a flowchart diagram of a KeithTree embodiment according to KeithTree Service 400. It should be noted that the KeithTree Service 400 can be regarded as an instance of the KeithTree Stage or the KeithTree module (1) mentioned earlier. In the illustrated embodiment, KeithTree Service 400 (e.g., KeithTree Stage, KeithTree module (1)) is depicted as a decision-making framework with nodes and decision loops, associated with a real-world disaster recovery event. KeithTree Service 400 includes handling real-world outages and determining failover targets for each data center based on customer resource groups.

Step 401 initiates a disaster recovery caused by an actual outage using a KeithTree decision-making process as per the illustrated embodiment for KeithTree Service 400. At step 401, a Global Data Center List (GDCL), which includes all data centers worldwide deemed or identified as non-responsive, is populated. The length of the GDCL, represented as N, corresponds to the number of data centers included. A data center is identified as non-responsive based on either business data related to that specific data center, a failure alert sent by the data center itself, or a global load balancer. The process proceeds to step 402. During the execution of the KeithTree Service 400 process, each data center in the GDCL is sequentially visited, according to the data center's position in the list, until the list is exhausted. For step 401, after the GDCL is populated, the process proceeds to step 402. Additionally, in some embodiments, the process may be repeated in a continuous loop (i.e., executing steps 401) based on the configurable frequency (e.g., administrator or user-specified intervals of a weeks, days, hours).

At step 402, the Global Data Center List (GDCL) is checked for exhaustion (i.e., whether it is empty or all data centers have been visited). If the GDCL is exhausted, the process ends. Otherwise, the process proceeds to step 403.

At step 403, the i-th data center from the GDCL is identified as non-responsive (e.g., experiencing an actual outage or failure) and referred to as the Actual Data Center Failure (ADF) for the current iteration of step 403. The process then moves to step 304.

At step 404, a Customer List (i.e., CL) associated with the Actual Data Center Failure (ADF) is populated. The Customer List (i.e., CL) includes all customers hosting services in the ADF. Each customer (j-th) in the CL is sequentially visited, according to the customer's position in the list, until the list is exhausted. Additionally, in some embodiments, the CL is prioritized, with higher-priority customers being assigned failover targets first (or visited first) in a later compiled table known as the Global Rebalance Table (GRT). For step 404, after the CL is populated, the process moves to step 405.

At step 405, the Customer List (i.e., CL) is checked for exhaustion (i.e., whether it is empty or all customers have been visited). If the CL is exhausted, the process returns to step 402 to visit the next data center in the Global Data Center List (GDCL). Otherwise, the process proceeds to step 406.

At step 406, a Customer Resource Group List (CRGL) associated with a j-th customer from the Customer List (i.e., CL) is populated. The CRGL includes all customer resource groups associated with the specific customer (j-th customer) in the current iteration of step 406. Each customer resource group (k-th) in the CRGL is sequentially visited according to the customer resource group's position in the list, until the list is exhausted. A customer resource group is a conceptual collection of resources required to operate a cloud service for a specific customer at a particular data center. Additionally, a customer resource group includes the costs associated with cloud usage or metering in the respective data center, as well as user rights assignments for the customer resource group. For step 406, after the CRGL is populated, the process moves to step 407.

At step 407, the Customer Resource Group List (CRGL) is checked for exhaustion (i.e., whether it is empty or all customer resource groups have been visited). If the CRGL is exhausted, the process returns to step 405 to visit the next customer in the Customer List (i.e., CL). Otherwise, the process proceeds to step 408.

At step 408, a Data Centers with Available Capacity List (DCACL) is populated for the k-th customer resource group (CRG) from the Customer Resource Group List (CRGL), for the j-th customer in the Customer List (CL), and for the i-th data center designated as the Actual Data Center (DDF). The DCACL includes all data centers worldwide that have available compute capacity. In some embodiments, the DCACL is prioritized based on geographic proximity, giving higher priority to data centers that are closer to the ADF. Each data center (z-th or DCAC) in the DCACL is sequentially visited, according to the data center's position in the list, until the list is exhausted or another condition is met. The DCACL does not include the ADF itself.

At step 409, the Data Centers with Available Capacity List (DCACL) is checked to determine if the list is exhausted (i.e., whether the list is empty or all data centers with available capacity (DCAC) have been visited in the list). If the DCACL is exhausted and no data centers with available capacity remain to serve as failover targets for one or more customer resource groups, an alert indicating “no available capacity” (not shown) is sent to the relevant cloud providers for those customer resource groups (in some embodiments), and the process ends. Otherwise, the process proceeds to step 410 with the current data center with available capacity designed as DCAC z-th.

At step 410, for the z-th data center in the DCACL, it is assessed whether the data center with available capacity (DCAC) has sufficient compute capacity to serve as a failover target for the k-th customer resource group (CRG). This determination involves calculating whether the current data center (DCAC z-th) can adequately support the CRG k-th. Specifically, if the sum of the cloud usage cost for the CRG k-th and the current or projected cloud usage cost of the data center DCAC z-th is less than or equal to the total compute capacity cost of DCAC z-th or a predetermined threshold, then DCAC z-th may be considered a suitable failover target. The relevant mathematical equation is as follows: Customer Resource Group Cloud Usage Cost+Data Center Current/Projected Cloud Usage Cost ¿=Data Center Total Compute Capacity Cost.

Continuing with step 410, if the condition specified by the relevant mathematical equation is satisfied (i.e., if the sum is less than or equal to the total capacity), the process proceeds to step 411, where an entry is added to the Global Rebalance Table (GRT) (or to a deployable architecture template) indicating that the current data center (DCAC z-th) is designated as the failover target for the k-th customer resource group (CRG). Additionally, the available capacity of DCAC z-th in the DCACL is reduced by the cloud usage cost of the CRG k-th. This reduction remains in effect until the simulation process of the KeithTree Service 400 is restarted or reinitiated. The process then returns to step 407 to evaluate the next customer resource group from the Customer Resource Group List (CRGL).

Alternatively, at step 410, if the above condition (i.e., relevant mathematical equation) is not met (i.e., the sum exceeds total capacity or no), the process then returns to step 409 to evaluate the next data center (DCAC) in DCACL.

Additionally, at step 411, the Global Rebalance Table (GRT) is made available to customers and other embodiments through API (application program interfaces) calls. The GRT contains information on the simulated failover targets for each resource group across all data center failure scenarios. The GRT can be used as input for deployment architectures.

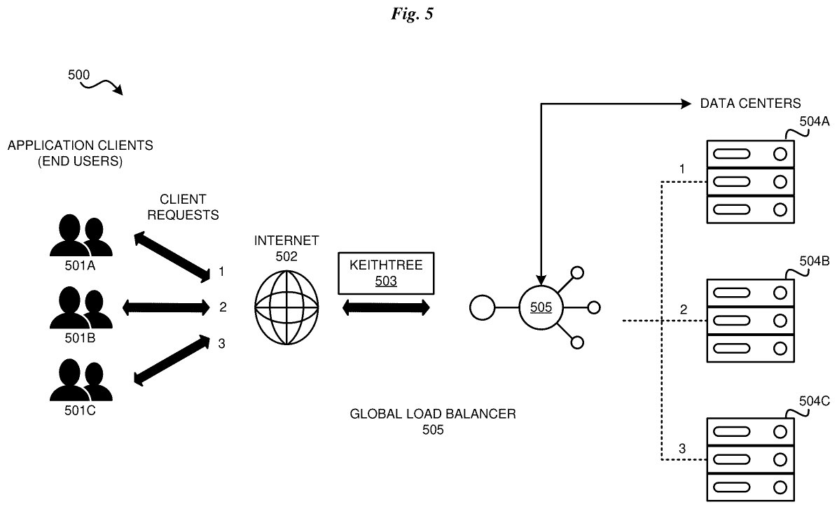

With reference to FIG. 5, this figure depicts a block diagram of an example KeithTree infrastructure according to KeithTree Infrastructure 500. It should be noted that the KeithTree module 503 can be regarded as an instance of the KeithTree Stage or the KeithTree module (1) mentioned earlier. In the illustrated embodiment, KeithTree Infrastructure 500 includes application clients (e.g., customers or end users) 501a-501c, client requests 1-3, internet 502, KeithTree module 503, global load balancer 505, and data centers 504a-504c. Application clients 501a-501c access cloud services through client requests 1-3 through the internet 502. Those client requests 1-3 are distributed or routed by global load balancer 505 to data centers 504a-504c. KeithTree module 503 is responsible for overseeing business data, metrics, and analytics related to the global load balancer 503 and data centers 504a through 504c. KeithTree module 503 receives reports from both the global load balancer 503 and data centers 504a to 504c. In the event of a simulated or actual outage or failure at one or more data centers, KeithTree service 503 provides load balancing and/or failover routing schemes and deployable architecture templates to global load balancer 505 (e.g., one or more global load balancers) and/or data centers 504a-504c. These load balancing and/or failover routing schemes deployable architectures templates advise how global load balancer 505 and data centers 504a-504c should manage the disaster recovery and failover assignments.

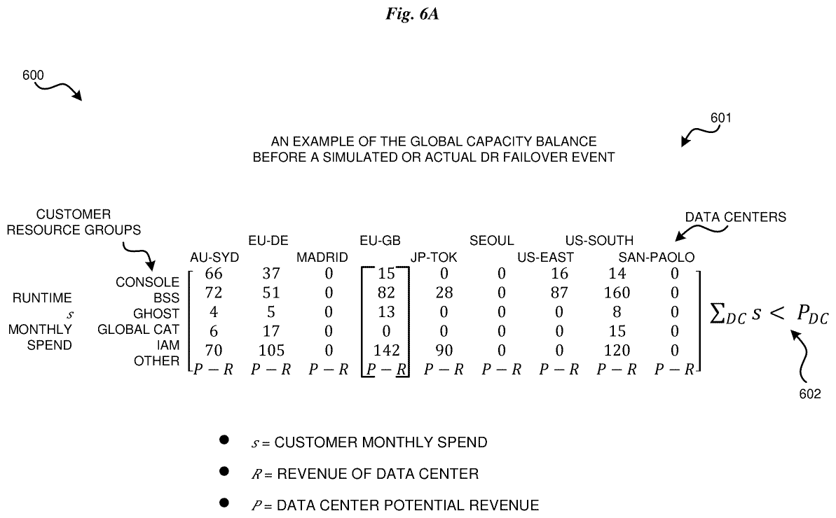

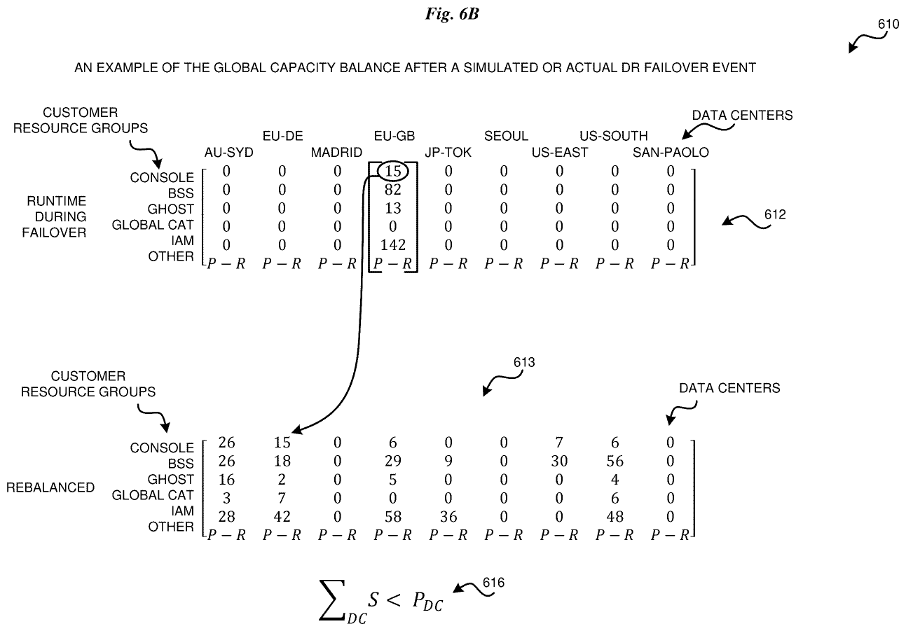

With reference to FIG. 6A, this figure depicts a block diagram 600 illustrating an example of the Global Capacity Balance before a simulated or actual DR Failover Event, in accordance with an illustrative embodiment. In the illustrated embodiment, block diagram 600 includes RunTime table 601 and equation 602. It should be noted that RunTime table 601 can be regarded as an instance of the Global Rebalance Table (GRT) mentioned earlier in various embodiments. Additionally, Runtime table 601 illustrates the state (i.e., typical or average moment-to-moment use of data center resources) of the Global Capacity Balance (e.g., Global Rebalance) before a simulated or actual DR failover event or execution of KeithTree Service 300 or KeithTree Service 400 or Global Rebalance Table (GRT) 208.

RunTime table 601 contains rows representing customer resource groups (except the last row) and columns representing globally located data centers. For example, rows such console, BSS, ghost, global, CAT, IAM, and OTHER are customer resource groups. A row for a customer resource group may be further associated with a particular customer S. S represents the sum of all computer resource groups by customer. The columns of RunTime table 601 include Au-Syd, EU-DE, Madrid, EU-GB, JP-TOK, Seoul, US-east, US-south, San-Paolo, which are global data centers. The last row of RunTime table 601 contains a constraint P-R per column. This constraint P-R represents the potential revenue for the data center in column minus the revenue of the data center, where the revenue is the sum of all rows in the particular column. Those skilled in the art would appreciate how to calculate the potential revenue for the data center. For example, in the EU-GB column (indicated in bold brackets), the sum of the rows (15+82+13+0+142) equals 252. Assuming the units of rows are in thousands of dollars, the revenue for EU-GB would be 252 thousand dollars. If the EU-GB data center's potential revenue is 500 thousand dollars, then the potential revenue (P) minus the actual revenue (R) would be a positive 248 thousand dollars, indicating excess or reserved capacity for the data center. The reserved capacity permits a data center to handle on-demand spikes in the usage of data center compute resources. Additionally, the rows may be determined by real-time usage metering reporting from Global Service BSS Metering and Billing Stage.

Equation 602,

$${\sum }_{DC}^{□} s < P DC ,$$

represents an inequality of the Global Capacity Balance that is recommended to be satisfied. It states that the summation of all entries in RunTime table 601 should be less than the summation of all the potential revenues of the columns or global data centers. In Equation 602, “S” is defined as the customer's monthly spend and includes all customer resource groups or rows (except the last) in RunTime table 601. Note that “S” can represent multiple customers, with each customer corresponding to one or more customer resource groups or rows. The summation of all entries in RunTime table 601 remains consistent.

if the inequality,

$${\sum }_{DC}^{□} s < PD C 602 ,$$

602, is not satisfied, it indicates that the total actual revenue across all data centers exceeds their combined potential revenue. This situation can lead to several issues, such as overcapacity (e.g., data centers operating beyond their intended capacity), service degradation (e.g., client may experience slower performance), increased cost (e.g., higher operational cost), and reduced resilience (e.g., reduced ability to handle additional spikes in demand or DR failover scenarios/events). Maintaining the inequality ensures that the data centers have enough reserved capacity to handle unexpected spikes in demand and maintain optimal performance and reliability.

With reference to FIG. 6B, this figure depicts block diagram 610 illustrating an example of the Global Capacity Balance after a simulated or actual DR Failover Event, in accordance with an illustrative embodiment. In the illustrated embodiment, block diagram 610 includes RunTime table 612, RunTime table 613 and equation XXX. RunTime tables 612 and 613 are similar to RunTime table 601. However, RunTime table 612 reflects the state of the Global Capacity Balance (e.g., Global Rebalance) after a simulated or actual DR failover event but before rebalancing. In contrast, RunTime table 613 shows the state of the Global Capacity Balance after the DR failover event and after rebalancing or the execution of KeithTree Service 300 or KeithTree Service 400.

In RunTime table 612, the EU-GB data center is designated as non-responsive. As part of applying KeithTree Service 300 or KeithTree Service 400, the EU-DE data center is identified as the geographically closest data center with available capacity, without exceeding EU-DE (P) potential capacity. Consequently, the customer resource group “console 15” is reassigned to the EU-DE data center. RunTime table 613 reflects this reassignment of customer resource group “console 15” is reassigned to the EU-DE data center. In some embodiments, KeithTree Service 300 or KeithTree Service 400 may also create a deployable architecture template (or an entry in the RunTime table 613) for the customer resource group “console,” with the EU-DE data center designated as the failover target. Equation 616,

$${\sum }_{DC}^{□} s < P DC ,$$

(same as Equation 602) represents an inequality of the Global Capacity Balance that is recommended to be satisfied after rebalancing occurs in RunTime table 613.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.” References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer implemented method for generating an optimum load balancing and failover load routing scheme during an actual disaster recovery event for a plurality of data centers, the computer implemented method comprising:
receiving business data associated with the plurality of data centers from a business support services (BSS) metering and billing service;
identifying a first data center, from the plurality of data centers, that is non-responsive, based at least in part on the business data;
identifying one or more customers associated with the first data center;
determining one or more customer resource groups linked the one or more customers;
identifying one or more responsive data centers, from the plurality of data centers, that have available compute capacity to serve as one or more failover targets, based at least in part on the business data;
constructing a global rebalance table (GRT) that associates the one or more customer resource groups with the one or more responsive data centers having available compute capacity to serve as the one or more failover targets; and
generating the optimum load balancing and failover load routing scheme based at least in part on the global rebalance table (GRT).

2. The method of claim 1, wherein: the receiving business data further comprises one or more of the following: a revenue, a billed usage, a revenue potential, business analytics, production capacity limits, a data center availability, a customer account, and a customer workload.

3. The method of claim 1, further comprises: outputting a deployable architecture template based, at least in part, on the optimum load balancing and failover load routing scheme.

4. The method of claim 3, wherein: the deployable architecture template is a Cloud Infrastructure as Code (IaC) component.

5. The method of claim 4, further comprises: uploading the deployable architecture template into a Cloud catalog.

6. The method of claim 1, wherein: the association between the one or more customer resource groups with the one or more responsive data centers that have available compute capacity to serve as the one or more failover targets is further based on a prioritization of the one or more customer resource groups by customer.

7. The method of claim 4, wherein: the deployable architecture template further includes a code to dynamically configure one or more Domain Name Service (DNS) resolvers.

8. A computer usable program product comprising one or more computer readable storage media, and program instructions collectively stored on the one or more computer readable storage media, the program instructions executable by a processor to cause the processor to perform operations for generating an optimum load balancing and failover load routing scheme during an actual disaster recovery event for a plurality of data centers comprising:
receiving business data associated with the plurality of data centers from a business support services (BSS) metering and billing service;
identifying a first data center, from the plurality of data centers, that is non-responsive, based at least in part on the business data;
identifying one or more customers associated with the first data center;
determining one or more customer resource groups linked the one or more customers;
identifying one or more responsive data centers, from the plurality of data centers, that have available compute capacity to serve as one or more failover targets, based at least in part on the business data;
constructing a global rebalance table (GRT) that associates the one or more customer resource groups with the one or more responsive data centers having available compute capacity to serve as the one or more failover targets; and
generating the optimum load balancing and failover load routing scheme based at least in part on the global rebalance table (GRT).

9. The computer usable program product of claim 8, wherein: the receiving business data further comprises one or more of the following: a revenue, a billed usage, a revenue potential, business analytics, production capacity limits, a data center availability, a customer account, and a customer workload.

10. The computer usable program product of claim 8, further comprises: outputting a deployable architecture template based, at least in part, on the optimum load balancing and failover load routing scheme.

11. The computer usable program product of claim 10, wherein: the deployable architecture template is a Cloud Infrastructure as Code (IaC) component.

12. The computer usable program product of claim 11, further comprises: uploading the deployable architecture template into a Cloud catalog.

13. The computer usable program product of claim 8, wherein: the association between the one or more customer resource groups with the one or more responsive data centers that have available compute capacity to serve as the one or more failover targets is further based on a prioritization of the one or more customer resource groups by customer.

14. The computer usable program product of claim 11, wherein: the deployable architecture template further includes a code to dynamically configure one or more Domain Name Service (DNS) resolvers.

15. A computer system comprising a processor and one or more computer readable storage media, and program instructions collectively stored on the one or more computer readable storage media, the program instructions executable by the processor to cause the processor to perform operations for generating an optimum load balancing and failover load routing scheme during an actual disaster recovery event for a plurality of data centers comprising:
receiving business data associated with the plurality of data centers from a business support services (BSS) metering and billing service;
identifying a first data center, from the plurality of data centers, that is non-responsive, based at least in part on the business data;
identifying one or more customers associated with the first data center;
determining one or more customer resource groups linked the one or more customers;
identifying one or more responsive data centers, from the plurality of data centers, that have available compute capacity to serve as one or more failover targets, based at least in part on the business data;
constructing a global rebalance table (GRT) that associates the one or more customer resource groups with the one or more responsive data centers having available compute capacity to serve as the one or more failover targets; and
generating the optimum load balancing and failover load routing scheme based at least in part on the global rebalance table (GRT).

16. The computer system of claim 15, wherein: the receiving business data further comprises one or more of the following: a revenue, a billed usage, a revenue potential, business analytics, production capacity limits, a data center availability, a customer account, and a customer workload.

17. The computer system of claim 15, further comprises: outputting a deployable architecture template based, at least in part, on the optimum load balancing and failover load routing scheme.

18. The computer system of claim 17, wherein: the deployable architecture template is a Cloud Infrastructure as Code (IaC) component.

19. The computer system of claim 18, further comprises: uploading the deployable architecture template into a Cloud catalog.

20. The computer system of claim 15, wherein: the association between the one or more customer resource groups with the one or more responsive data centers that have available compute capacity to serve as the one or more failover targets is further based on a prioritization of the one or more customer resource groups by customer.

21. A computer implemented method for generating an optimum load balancing and failover load routing scheme during a stimulated disaster recovery event for a plurality of data centers, the computer implemented method comprising:
receiving business data associated with the plurality of data centers from a business support services (BSS) metering and billing service;
identifying a first data center, from the plurality of data centers, that is non-responsive, based at least in part on the business data;
identifying one or more customers associated with the first data center;
determining one or more customer resource groups linked the one or more customers;
identifying one or more responsive data centers, from the plurality of data centers, that have available compute capacity to serve as one or more failover targets, based at least in part on the business data;
constructing a global rebalance table (GRT) that associates the one or more customer resource groups with the one or more responsive data centers having available compute capacity to serve as the one or more failover targets; and
generating the optimum load balancing and failover load routing scheme based at least in part on the global rebalance table (GRT).

22. The method of claim 21, wherein: the receiving business data further comprises one or more of the following: a revenue, a billed usage, a revenue potential, business analytics, production capacity limits, a data center availability, a customer account, and a customer workload.

23. The method of claim 21, further comprises: outputting a deployable architecture template based, at least in part, on the optimum load balancing and failover load routing scheme.

24. The method of claim 23, wherein: the deployable architecture template is a Cloud Infrastructure as Code (IaC) component.

25. A computer usable program product comprising one or more computer readable storage media, and program instructions collectively stored on the one or more computer readable storage media, the program instructions executable by a processor to cause the processor to perform operations for generating an optimum load balancing and failover load routing scheme during a stimulated disaster recovery event for a plurality of data centers comprising:
receiving business data associated with the plurality of data centers from a business support services (BSS) metering and billing service;
identifying a first data center, from the plurality of data centers, that is non-responsive, based at least in part on the business data;
identifying one or more customers associated with the first data center;
determining one or more customer resource groups linked the one or more customers;
identifying one or more responsive data centers, from the plurality of data centers, that have available compute capacity to serve as one or more failover targets, based at least in part on the business data;
constructing a global rebalance table (GRT) that associates the one or more customer resource groups with the one or more responsive data centers having available compute capacity to serve as the one or more failover targets; and
generating the optimum load balancing and failover load routing scheme based at least in part on the global rebalance table (GRT).
